(19) United States
(12) Patent Application Publication
(10) Pub. No.: US 2024/0221715 A1
(43) Pub. Date: Jul. 4, 2024

(54) DETECTION OF NOISE SUPPRESSION PROCESSING CAPABILITY OF CONNECTED DEVICES

(71) Applicant: Intel Corporation, Santa Clara, CA (US)

(72) Inventors: Jaison FERNANDEZ, Bangalore (IN); Sumod CHERUKKATE, Bangalore (IN); Tarakesava Reddy KOKI, Hyderabad (IN); Adam KUPRYJANOW, Gdansk (PL); Srikanth POTLURI, Folsom, CA (US)

(21) Appl. No.: 18/090,427

(22) Filed: Dec. 28, 2022

(51) Int. Cl. G10K 11/178; H04R 1/10

(52) U.S. Cl. CPC G10K 11/17823; G10K 11/17873; H04R 1/1083; G10K 2210/1081; G10K 2210/30231; G10K 2210/3027; G10K 2210/3036; H04R 2460/01

(57) ABSTRACT

This disclosure describes systems, methods, and devices related to noise suppression processing. A device may establish a connection to a connected device. The device may calculate a first SNR of a first sample of a first audio stream from the connected device. The device may calculate a second SNR of a second sample of a second audio stream from a first device. The device may compare a difference of the first SNR and the second SNR to a Delta SNR threshold. The device may detect ambient noise level conditions and the Delta SNR threshold is based on the ambient noise level conditions. The device may determine whether to apply system-level preprocessing based on the comparison.

### TECHNICAL FIELD

This disclosure generally relates to systems and methods for noise suppression processing and, more particularly, to detect the noise suppression processing capability of connected devices.

### BACKGROUND

As the modern workforce becomes more distributed and more people work out of home offices, cafes, and shared workspaces, increasingly there is a need for digital collaboration tools that make it easier to collaborate remotely and in ad hoc situations. One of the major concerns for audio collaboration is the background noise like dynamic noise (children crying, munching, dog barking, café chatter, etc.) along with stationary noise (microwave, fan noise, AC, lawn mowers, etc.). This will result in a degraded user experience.

### BRIEF DESCRIPTION OF THE DRAWINGS

FIG. 1A illustrates an example computing device including audio processing, in accordance with one or more example embodiments of the present disclosure.

FIG. 1B illustrates hardware and software for performing audio processing, in accordance with one or more example embodiments of the present disclosure.

FIGS. 2-5 depict illustrative schematic diagrams for noise suppression processing, in accordance with one or more example embodiments of the present disclosure.

FIG. 6 illustrates a flow diagram of a process for an illustrative noise suppression processing system, in accordance with one or more example embodiments of the present disclosure.

FIG. 7 is a block diagram illustrating an example of a computing device or computing system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Silicon vendors are implementing powerful background noise algorithms as part of the audio/neural engine to give a good collaboration experience. This noise algorithm works only when the user uses the system's built-in microphones. During the usage of a headset (HS) that is either through the universal serial bus (USB) wired or Bluetooth® (BT), the noise cancellation is left with the headset and the system/system on a chip (SoC) audio/neural engine will not do any noise cancellation for this path. With USB/BT headset two scenarios are possible: either noise canceling processing is done on a headset or the headset will not perform noise cancellation processing.

If there is an automatic way to detect whether a USB/BT headset does not have any noise canceling processing capability, then a system's noise suppression capability may be applied to the USB/BT headset microphone audio stream. This will provide the user with a similar audio collaboration experience over different USB/BT headset (irrespective of headset noise cancellation capability). Currently, there are no automatic solutions exist to determine the headset noise cancellation processing.

BT specification has a mechanism for peripherals to expose the noise cancellation and echo cancellation to the host controller. Some headsets provide manual solutions for tuning/disabling/enabling capability with their driver and application pack.

A mechanism of reporting noise cancellation and echo cancellation is not widely implemented/enabled in an echo system. Potential double processing of audio streams could cause a sound quality reduction. The manual time-consuming effort required from the user to perform tuning of the USB/BT headset audio effects (noise canceling) using the driver and application pack.

Example embodiments of the present disclosure relate to systems, methods, and devices for the detection of noise suppression processing of BT and USB headsets and enhance the user audio experience through host capabilities.

In one or more embodiments, a noise suppression processing system may facilitate a novel way to detect the level of noise suppression processing capability present in the BT/USB headset. It is done by comparing the device's built-in microphone audio stream with the audio stream captured by USB/BT headset.

In one or more embodiments, a noise suppression processing system may detect whether a headset has noise cancellation processing, if not the system's noise cancellation algorithm may be applied.

In one or more embodiments, a noise suppression processing system may avoid any double processing of the audio stream for noise cancellation and improve the quality of the USB/BT headsets that has no noise cancellation capability.

A noise suppression processing system may provide a better audio collaboration experience by adding system dynamic noise cancellation support to the BT/USB headset (based on detecting the noise cancellation processing capability on the headset) and avoid any double processing of the audio stream for noise cancellation.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

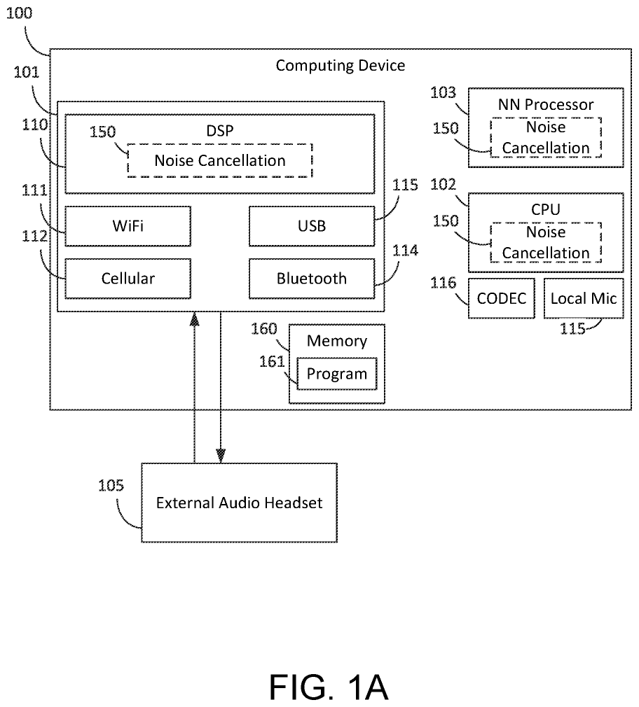

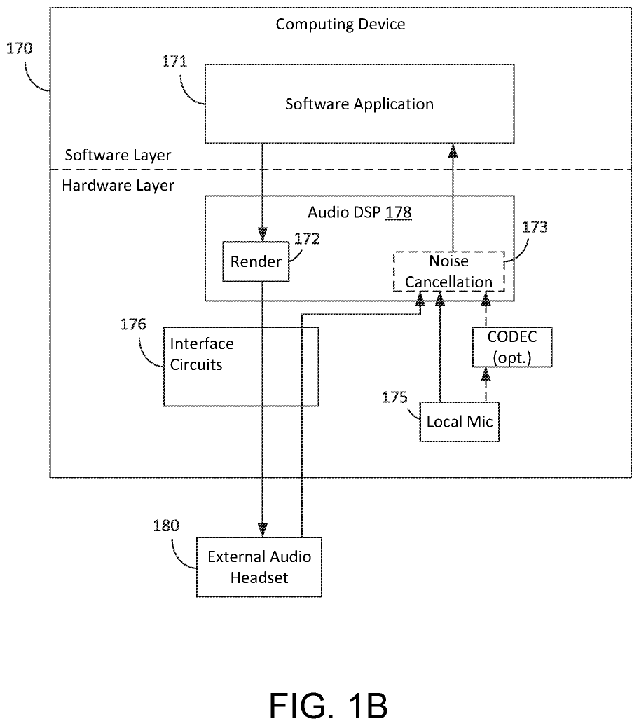

FIG. 1A illustrates an example computing device including audio processing according to various embodiments. As mentioned above, various embodiments of the present disclosure may perform audio processing functions using different components of a computing device. In this example, a computing device includes a DSP, CPU, and neural network processor, but in other embodiments, a computing device may have fewer than all of these components or only one of these components, for example. The present example is illustrative of the various locations where noise cancellation may occur.

For example, computing device 100 may include a CPU 102, NN processor 103, chipset 101, local microphone (“mic”) 115, and coder/decoder (“CODEC”) 116. Chipset 101 may include, for example, circuits for a DSP 110, high-speed wireless networking (e.g., 802.11xx or “WiFi”) 111, wireless connectivity (e.g., Bluetooth) 115, Cellular 112, or one or more wired connections (e.g., USB) 114. An external audio headset, for example, may connect to the computer using a wired or wireless connection through one of the chipset components (e.g., Bluetooth or USB). Local mic 115 may be a digital or analog microphone, for example. In one embodiment, local mic 115 is an analog microphone having an output coupled to CODEC 116, and CODEC 116 may provide a local audio signal, for example. In another embodiment, local mic 115 is a digital microphone having a digital output for carrying the local audio signal, for example. In various alternative embodiments, noise cancellation 150 may be implemented in hardware in the DSP 110 or in software in the CPU 102 or NN processor 103. As mentioned above, NN processor 103 and/or DSP 110 may be included on the same integrated circuit as CPU 102, for example. While DSP 110 is considered a hardware implementation, it is to be understood the DSP, CPU, and NN processor(s) implement their functions, to varying degrees, based on a program 161 stored in a non-transitory machine-readable medium (e.g., memory 160). Such a program 161 is executable by the one or more processors and includes sets of instructions for configuring the DSP, CPU, or NN processor to perform their functions, for example.

In various embodiments, computing device 100 may be a notebook (aka laptop) computer, a tablet computer (e.g., an iPad, Kindle, or Nook), or a mobile communications computer (e.g., a handheld phone, smartwatch, etc. . . . ). It is to be understood that such devices may include one or more microphones that may be placed at various locations on the computing device. External audio may be received from an external headset, earpiece, or other devices that provide a second microphone with spatial diversity from the microphone on the computing device, for example. Additionally, in one embodiment, microphone 115 may be an omni-directional microphone. Further, in some embodiments, a microphone on an external device may be a directional microphone, for example.

Features and advantages of the present disclosure may combine audio inputs from the local microphone and the microphone on the external headset to improve the quality of the upstream audio. Therefore, instead of running the noise cancellation algorithm in the external headset, it may be implemented in the computing device itself, where the intended audio signal (e.g., the voice of the person with the headset) is separated from the surrounding noises (e.g., including voices from other people) and enhanced to achieve premium audio quality. The ambient microphone(s) signal in the computing device 100 can be routed directly to the chipset or through optional external audio CODEC 116 (e.g., through a Soundwire or High Definition Audio interface). The voice data from the external headset may be routed either through USB interface or through a Bluetooth interface.

FIG. 1B illustrates hardware and software for performing audio processing of a computing device 170, according to an embodiment. In this example, noise cancellation 173 is implemented in audio DSP 178. An external headset 180 detects audio sends an audio signal to audio DSP 178 (e.g., via interface circuits 176, such as Bluetooth or USB), and a local microphone (e.g., on a notebook) detects the same audio and sends the audio signal to audio DSP 178, audio DSP 178 performs noise cancellation 173. The audio signal, with noise canceled, may be sent to a software application 171 (e.g., Skype, WebEx, WhatsApp, etc. . . . ), which may send the noise canceled audio signal to a recipient. As shown in this example, the noise canceled audio signal is sent to the external headset 180 via a rendering component 172 and interface circuits 176.

It is understood that the above descriptions are for purposes of illustration and are not meant to be limiting.

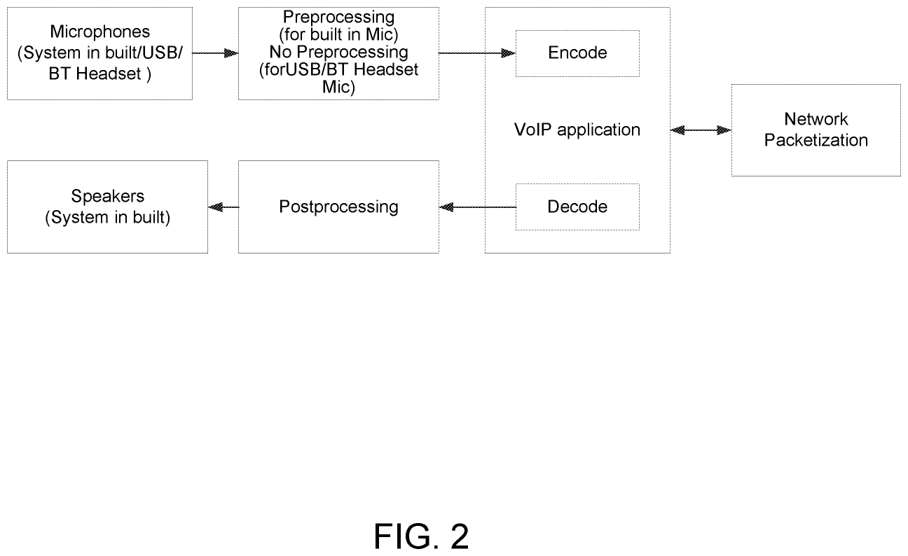

FIG. 2 depicts an illustrative schematic diagram for noise suppression processing, in accordance with one or more example embodiments of the present disclosure.

Referring to FIG. 2, there is shown a data flow in a VoIP call using a system's built-in microphone or USB/BT headset microphone and speakers.

The audio experience is a critical part of any virtual collaboration experience. Either a system's built-in audio devices (speakers and microphone) or an external headset over BT/USB may be used for the audio.

FIG. 2 is a typical audio input/output data flow pipeline for a voice-over IP (VOIP) call application. The input pipeline has input transducers (microphones), an audio stream preprocessing stage, an encoding stage for VOIP applications, and the network packetization section. The output pipeline has a network packetization stage, a decoder for VoIP application, post-processing stage, and output transducers (Speakers) sections.

For the built-in microphone scenario, the system will apply various preprocessing techniques like Automatic Echo cancellation, De-Reverb, Beamforming, Dynamic Noise cancellation, Automatic Gain Control, etc. to the input audio stream to enhance the audio collaboration experience.

For USB/BT headsets, a system does not add any preprocessing to the input audio stream, depending on the endpoint device (BT/USB headset) noise suppression processing capabilities. As stated above, the USB/BT headset noise cancellation capability varies from excellent to nothing based on the price range and quality of the headset.

The main reason why adding any of the existing system level preprocessing methods to a USB/BT headset audio input stream is not possible is because it is not known whether the endpoint (BT/USB headset) has any noise suppression processing capability or not (in order to avoid any double noise processing of the audio streams by headset and system). Double processing will affect the quality of the audio signal.

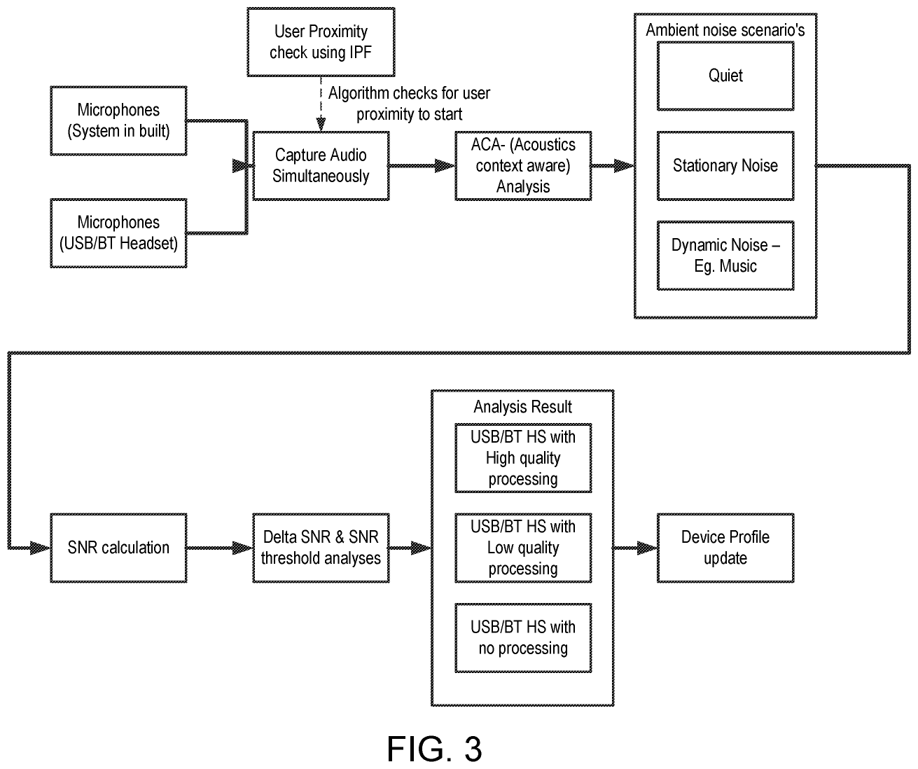

FIG. 3 depicts an illustrative schematic diagram for noise suppression processing, in accordance with one or more example embodiments of the present disclosure.

Referring to FIG. 3, there is shown a USB/BT headset endpoint preprocessing capability detection block diagram.

In one or more embodiments, a noise suppression processing system may facilitate a novel method to dynamically detect the noise processing capability of the USB/BT headset by comparing the SNR of the device with that of the laptop built-in microphone audio streams as a reference stream.

Whenever a new BT/USB device is connecting to the system, simultaneous capture of the speech audio steams is performed for a minimum time (e.g., about 10 seconds or other time) that is sufficient to calculate the SNR of the streams through the system built-in microphone and USB/BT headset.

In one or more embodiments, a noise suppression processing system may detect the ambient noise environment (e.g., quiet, static noise, dynamic noise—music, etc.). If the initial capture of the audio stream is not long enough for the SNR analysis, the noise suppression processing system may continuously sample the built-in microphone stream along with BT/HS audio sample to calculate the SNR on both streams and compare them to thresholds.

In one or more embodiments, a noise suppression processing system may check whether the user (hence the BT headset go to sleep go to sleep,) is nearby the system using various user proximity techniques, if not, the noise suppression processing system may wait until the user is proximate to the system.

Once the simultaneous capture of the speech audio streams is completed, the noise suppression processing system may calculate the SNR of the audio streams and perform a delta SNR threshold analysis.

Delta SNR Value=USB BT Headset Audio Streams SNR−Built-In Mic Audio Stream SNR

In one or more embodiments, a noise suppression processing system may use the delta SNR to compare against a predefined SNR threshold in Table 1 for various scenarios. In one or more embodiments, a noise suppression processing system may categorize the USB/BT headsets into three categories as follows:
Good noise reduction processing headset.
Low noise reduction processing headset.
No noise reduction processing headset.

Delta SNR thresholds for different ambient noise scenarios on Table 1 are derived based on experimentation.

TABLE 1
Delta SNR threshold for various ambient noise scenarios

| | Quiet | Static Noise | Music |
|---|---|---|---|
| SNR threshold - Good processing | >20 | >35 | >30 |
| SNR threshold - Low processing | >20 | >30 & <35 | >20 & <30 |
| SNR threshold - No processing | >20 | <30 | <20 |

Once the headset noise reduction processing capability of the device is determined, a device profile list with its processing capability is created for future use. The device noise reduction processing capability profile list is used for the detection process on a per device basis.

It should be noted that in the case of a first audio sampling, an ambient noise environment delta SNR may not be sufficient to accurately detect headset noise reduction processing capability. In that scenario, a noise suppression processing system may continue to run to detect the delta SNR in a different ambient noise environment.

In one or more embodiments, a speech SNR analysis proof of concept (POC) done with six different headsets (USB/BT; premium/medium/low cost) in various ambient noise environments (quiet, static noise—hair dryer, dynamic noise music, etc.) to determine the SNR threshold for various ambient scenarios.

Table 2 and Table 3 below show the POC results.

TABLE 2
POC delta SNR results (BT headset
audio − Internal Mic RAW audio)

| | | SNR difference (BT/USB Headset | | |
|---|---|---|---|---|
| | | audio − Internal Mic RAW audio) | | |
| Si# | Headset Type | Quiet | Static Noise | Music |
| 1 | BT HS 1 (Premium - | 21 | 38 | 35 |
| | with ANC ON) | | | |
| 2 | BT HS 1 (Premium - | 19 | 39 | 26 |
| | with ANC OFF | | | |
| 3 | BT HS 3 (Low cost) | 33 | 27 | 8 |
| 4 | USB HS 1 (Medium | 30 | 36 | 19 |
| | range) | | | |
| 5 | BT HS 4 (Low cost) | 23 | 42 | 31 |
| 6 | BT HS 5 (Low cost) | 20 | 29 | 17 |

TABLE 3
Conclusions of USB/BT headset delta SNR analysis POC

| Si# | Headset performance conclusions |
|---|---|
| 1&2 | HS has a very good noise reduction feature |
| 3 | HS has poor quality of noise reduction feature: it does not perform |
| | well in music conditions, and is very aggressive in clean |
| 4 | HS has poor quality noise reduction feature (it does not perform |
| | well in music conditions) |
| 5 | HS does not have noise processing; it has good quality HW design |
| 6 | HS does not have noise processing |

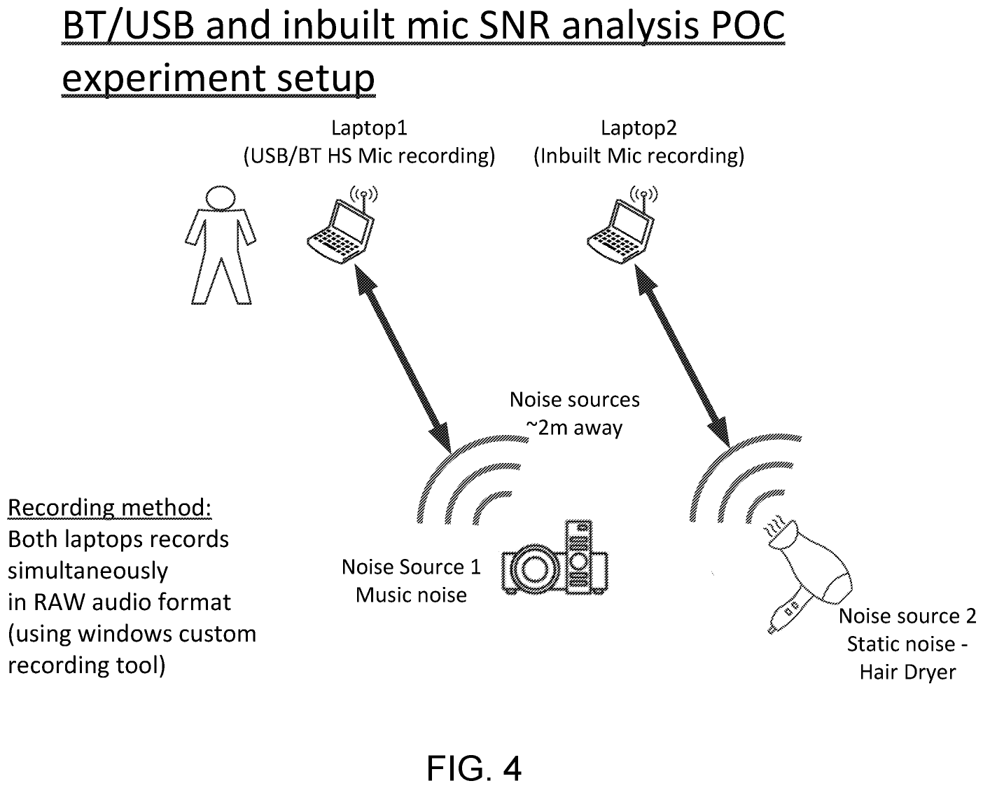

FIG. 4 depicts an illustrative schematic diagram for noise suppression processing, in accordance with one or more example embodiments of the present disclosure.

Referring to FIG. 4, there is shown a BT/USB and built-in microphone SNR analysis POC experiment setup. Specifically, there is shown the setup used to simultaneously capture audio streams from the system's built-in microphone along with BT/USB headset for the SNR analysis. Since the existing laptops would not allow the recording of two audio streams simultaneously (not a limitation for the actual implementation), two systems were used for the recording (Laptop1 was used to connect USB/BT headset and Laptop2 for the built-in microphone). We run separate RAW audio recordings with 3 different ambient (Quiet, Music noise, hair dryer noise) conditions for 6 different USB/BT headset.

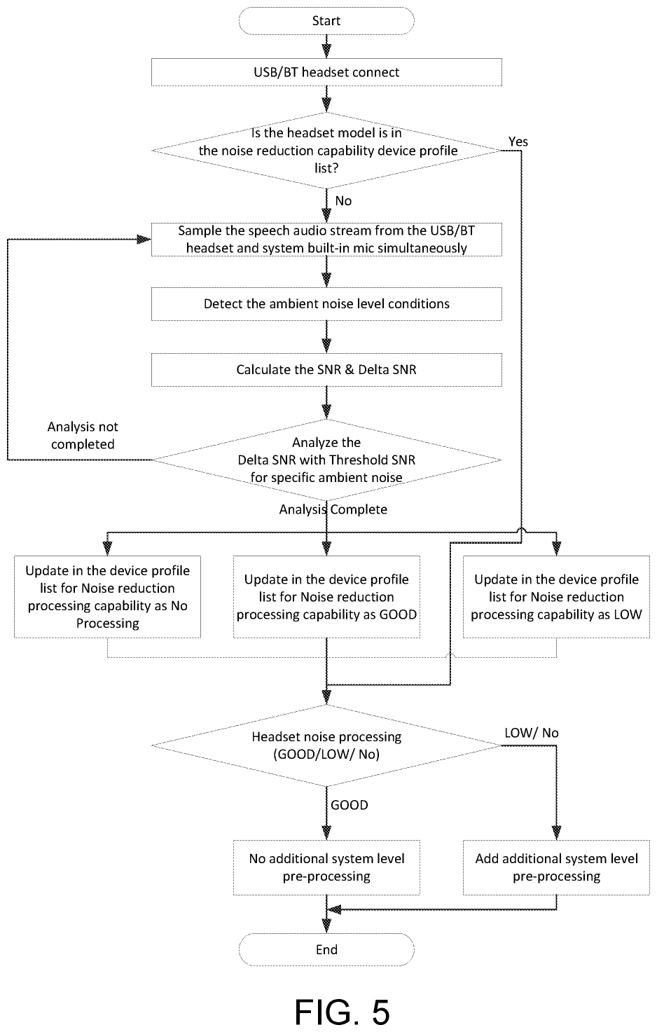

FIG. 5 depicts an illustrative schematic diagram for noise suppression processing, in accordance with one or more example embodiments of the present disclosure.

Referring to FIG. 5, there is shown a flow chart of USB/BT headset audio input preprocessing detection.

The process starts with a connection to a USB or Bluetooth headset. It should be understood that USB or Bluetooth headsets are used as an illustration and not meant to be limiting. Other types of devices may also be connected through other means.

A noise suppression processing system may determine if the headset exists in a noise reduction capability device profile list. If the answer is yes, the noise suppression processing system may determine the headset noise processing from the list. Based on that, the noise suppression processing system may determine whether to apply additional system level pre-processing or not. The headset noise processing found in the list may be a good processing capability, a low processing capability, or a no processing capability. In case the connected device is not in the noise reduction capability device profile list, the noise suppression processing system may sample an audio stream from the connected device and sample another audio stream from the built-in microphone simultaneously. The noise suppression processing system may also detect ambient noise level conditions. This may be performed by any means of acoustics context-aware algorithms or devices. The noise suppression processing system may calculate the relative signal-to-noise ratio (SNR) and Delta SNR. The noise suppression processing system may then analyze the Delta SNR with a threshold SNR for a specific ambient noise. Based on that, the noise suppression processing system may then update the device profile list for noise reduction processing capability. Based on the capability, the noise suppression processing system may then determine whether to apply additional system level pre-processing or not.

In one or more embodiments, a noise suppression processing system may facilitate sharing or updating the USB/BT headset profile using an online database.

In one or more embodiments, a noise suppression processing system may further enhance the accuracy of the noise reduction capability detection by playing (with user permission for headset calibration and keeping the headset near built-in microphones) a small test audio stream, containing artificial noise stream combinations, through speakers of a laptop and simultaneously capture using built-in microphones and USB/BT headset. By comparing the noise suppression capability against the test streams, it is possible to detect the level of preprocessing capability in headsets more accurately. If the system preprocessing capability is better and in case the headset has the capability to avoid noise cancellation algorithms (through a driver setting), a noise suppression processing system may request the headset not to perform noise cancellation and perform the full noise cancellation at the system level.

In one or more embodiments, additional definitions may be added to the standard to expose each of the audio effects present in the USB/BT peripherals, so that the system can compensate for the missing capabilities of the peripherals.

It is understood that the above descriptions are for purposes of illustration and are not meant to be limiting.

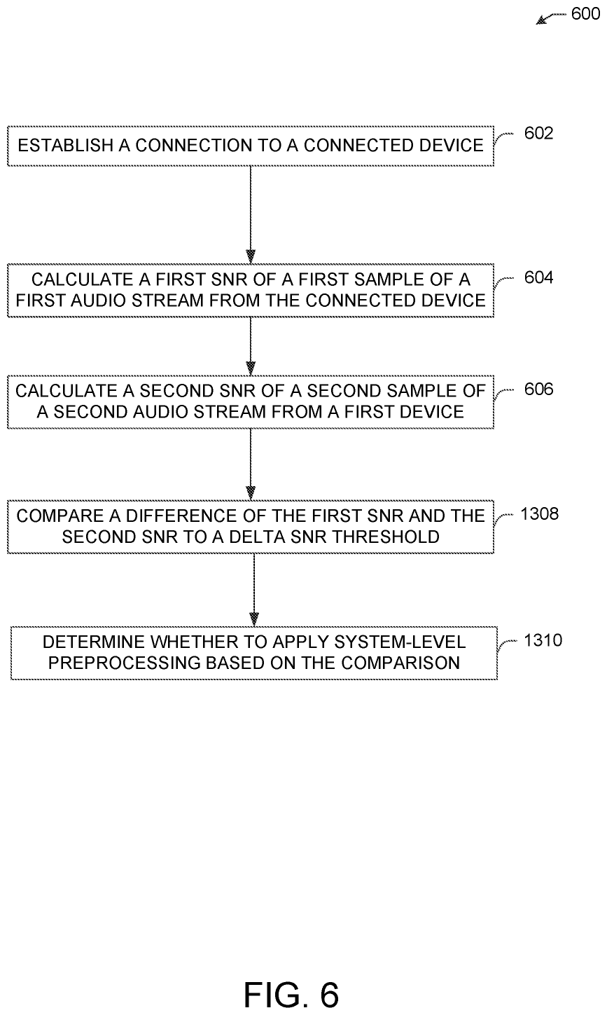

FIG. 6 illustrates a flow diagram of a process 600 for a noise suppression processing system, in accordance with one or more example embodiments of the present disclosure.

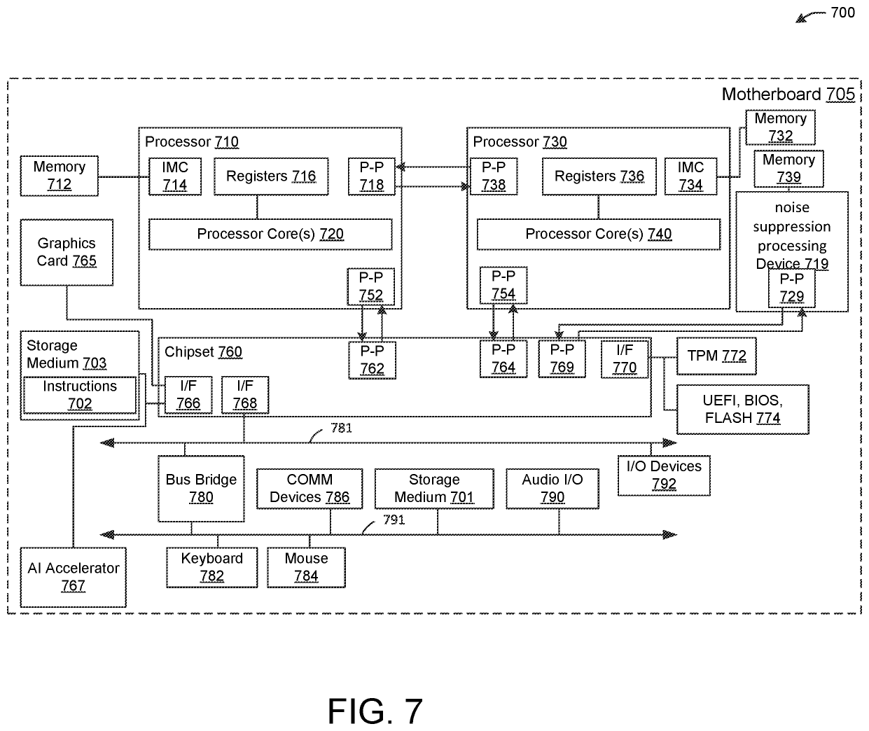

At block 602, a device (e.g., the noise suppression processing device 719 of FIG. 7) may establish a connection to a connected device.

At block 604, the device may calculate a first SNR of a first sample of a first audio stream from the connected device.

At block 606, the device may calculate a second SNR of a second sample of a second audio stream from a first device.

At block 608, the device may compare a difference of the first SNR and the second SNR to a Delta SNR threshold; and

At block 610, the device may determine whether to apply system-level preprocessing based on the comparison.

It is understood that the above descriptions are for purposes of illustration and are not meant to be limiting.

FIG. 7 illustrates an embodiment of an exemplary system 700, in accordance with one or more example embodiments of the present disclosure.

In various embodiments, the computing system 700 may comprise or be implemented as part of an electronic device.

In some embodiments, the computing system 700 may be representative, for example, of a computer system that implements one or more components of FIGS. 1A-1B.

The embodiments are not limited in this context. More generally, the computing system 700 is configured to implement all logic, systems, processes, logic flows, methods, equations, apparatuses, and functionality described herein.

The system 700 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 700 may have a single processor with one core or more than one processor. Note that the term “processor” refers to a processor with a single core or a processor package with multiple processor cores.

The computing system 700 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 700. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 700 comprises a motherboard 705 for mounting platform components. The motherboard 705 is a point-to-point interconnect platform that includes a processor 710, a processor 730 coupled via a point-to-point interconnects as an Ultra Path Interconnect (UPI), and a noise suppression processing device 719. In other embodiments, the system 700 may be of another bus architecture, such as a multi-drop bus. Furthermore, each of processors 710 and 730 may be processor packages with multiple processor cores. As an example, processors 710 and 730 are shown to include processor core(s) 720 and 740, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 710 and the chipset 760. Some platforms may include additional components and some platforms may only include sockets to mount the processors and/or the chipset.

The processors 710 and 730 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 710, and 730.

The processor 710 includes an integrated memory controller (IMC) 714, registers 716, and point-to-point (P-P) interfaces 718 and 752. Similarly, the processor 730 includes an IMC 734, registers 736, and P-P interfaces 738 and 754. The IMC's 714 and 734 couple the processors 710 and 730, respectively, to respective memories, a memory 712 and a memory 732. The memories 712 and 732 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 712 and 732 locally attach to the respective processors 710 and 730.

In addition to the processors 710 and 730, the system 700 may include a noise suppression processing device 719. The noise suppression processing device 719 may be connected to chipset 760 by means of P-P interfaces 729 and 769. The noise suppression processing device 719 may also be connected to a memory 739. In some embodiments, the noise suppression processing device 719 may be connected to at least one of the processors 710 and 730. In other embodiments, the memories 712, 732, and 739 may couple with the processor 710 and 730, and the noise suppression processing device 719 via a bus and shared memory hub.

System 700 includes chipset 760 coupled to processors 710 and 730. Furthermore, chipset 760 can be coupled to storage medium 703, for example, via an interface (I/F) 766. The I/F 766 may be, for example, a Peripheral Component Interconnect-enhanced (PCI-e). The processors 710, 730, and the noise suppression processing device 719 may access the storage medium 703 through chipset 760.

Storage medium 703 may comprise any non-transitory computer-readable storage medium or machine-readable storage medium, such as an optical, magnetic or semiconductor storage medium. In various embodiments, storage medium 703 may comprise an article of manufacture. In some embodiments, storage medium 703 may store computer-executable instructions, such as computer-executable instructions 702 to implement one or more of processes or operations described herein, (e.g., process 600 of FIG. 6). The storage medium 703 may store computer-executable instructions for any equations depicted above. The storage medium 703 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 710 couples to a chipset 760 via P-P interfaces 752 and 762 and the processor 730 couples to a chipset 760 via P-P interfaces 754 and 764. Direct Media Interfaces (DMIs) may couple the P-P interfaces 752 and 762 and the P-P interfaces 754 and 764, respectively. The DMI may be a high-speed interconnect that facilitates, e.g., eight Giga Transfers per second (GT/s) such as DMI 3.0. In other embodiments, the processors 710 and 730 may interconnect via a bus.

The chipset 760 may comprise a controller hub such as a platform controller hub (PCH). The chipset 760 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 760 may comprise more than one controller hub such as a chipset with a memory controller hub, a graphics controller hub, and an input/output (I/O) controller hub.

In the present embodiment, the chipset 760 couples with a trusted platform module (TPM) 772 and the UEFI, BIOS, Flash component 774 via an interface (I/F) 770. The TPM 772 is a dedicated microcontroller designed to secure hardware by integrating cryptographic keys into devices. The UEFI, BIOS, Flash component 774 may provide pre-boot code.

Furthermore, chipset 760 includes the I/F 766 to couple chipset 760 with a high-performance graphics engine, graphics card 765. In other embodiments, the system 700 may include a flexible display interface (FDI) between the processors 710 and 730 and the chipset 760. The FDI interconnects a graphics processor core in a processor with the chipset 760.

Various I/O devices 792 couple to the bus 781, along with a bus bridge 780 which couples the bus 781 to a second bus 791 and an I/F 768 that connects the bus 781 with the chipset 760. In one embodiment, the second bus 791 may be a low pin count (LPC) bus. Various devices may couple to the second bus 791 including, for example, a keyboard 782, a mouse 784, communication devices 786, a storage medium 701, and an audio I/O 790.

The artificial intelligence (AI) accelerator 767 may be circuitry arranged to perform computations related to AI. The AI accelerator 767 may be connected to storage medium 703 and chipset 760. The AI accelerator 767 may deliver the processing power and energy efficiency needed to enable abundant-data computing. The AI accelerator 767 is a class of specialized hardware accelerators or computer systems designed to accelerate artificial intelligence and machine learning applications, including artificial neural networks and machine vision. The AI accelerator 767 may be applicable to algorithms for robotics, internet of things, other data-intensive and/or sensor-driven tasks.

Many of the I/O devices 792, communication devices 786, and the storage medium 701 may reside on the motherboard 705 while the keyboard 782 and the mouse 784 may be add-on peripherals. In other embodiments, some or all the I/O devices 792, communication devices 786, and the storage medium 701 are add-on peripherals and do not reside on the motherboard 705.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The following examples pertain to further embodiments.

Example 1 may include a system that comprises at least one memory that stores computer-executable instructions; and at least one processor configured to access the at least one memory and execute the computer-executable instructions to: establish a connection to a connected device; calculate a first SNR of a first sample of a first audio stream from the connected device; calculate a second SNR of a second sample of a second audio stream from a first device; compare a difference of the first SNR and the second SNR to a Delta SNR threshold; and determine whether to apply system-level preprocessing based on the comparison.

Example 2 may include the system of example 1 and/or some other example herein, wherein the first sample and the second sample are captured simultaneously.

Example 3 may include the system of example 1 and/or some other example herein, wherein the connected device may be a universal serial bus (USB) or a Bluetooth® device.

Example 4 may include the system of example 1 and/or some other example herein, wherein the processing circuitry may be further configured to detect ambient noise level conditions.

Example 5 may include the system of example 4 and/or some other example herein, wherein the Delta SNR threshold may be based on the ambient noise level conditions.

Example 6 may include the system of example 1 and/or some other example herein, wherein the processing circuitry may be further configured to update a profile list associated with a noise reduction processing capability of the connected device.

Example 7 may include the system of example 1 and/or some other example herein, wherein a processing capability of the connected device comprises a no processing capability, a good processing capability, or a low processing capability.

Example 8 may include the system of example 7 and/or some other example herein, wherein the processing circuitry may be further configured to: determine that the connected device processing capability may be good; and determine no additional system level pre-processing may be needed.

Example 9 may include the system of example 7 and/or some other example herein, wherein the processing circuitry may be further configured to: determine that the connected device processing capability may be low or no processing; and add additional system level pre-processing.

Example 10 may include a non-transitory computer-readable medium storing computer-executable instructions which when executed by one or more processors result in performing operations comprising: establishing a connection to a connected device; calculating a first SNR of a first sample of a first audio stream from the connected device; calculating a second SNR of a second sample of a second audio stream from a first device; comparing a difference of the first SNR and the second SNR to a Delta SNR threshold; and determining whether to apply system-level preprocessing based on the comparison.

Example 11 may include the non-transitory computer-readable medium of example 10 and/or some other example herein, wherein the first sample and the second sample are captured simultaneously.

Example 12 may include the non-transitory computer-readable medium of example 10 and/or some other example herein, wherein the connected device may be a universal serial bus (USB) or a Bluetooth® device.

Example 13 may include the non-transitory computer-readable medium of example 10 and/or some other example herein, wherein the operations further comprise detecting ambient noise level conditions.

Example 14 may include the non-transitory computer-readable medium of example 13 and/or some other example herein, wherein the Delta SNR threshold may be based on the ambient noise level conditions.

Example 15 may include the non-transitory computer-readable medium of example 10 and/or some other example herein, wherein the operations further comprise update a profile list associated with a noise reduction processing capability of the connected device.

Example 16 may include the non-transitory computer-readable medium of example 10 and/or some other example herein, wherein a processing capability of the connected device comprises a no processing capability, a good processing capability, or a low processing capability.

Example 17 may include the non-transitory computer-readable medium of example 16 and/or some other example herein, wherein the operations further comprise: determining that the connected device processing capability may be good; and determining no additional system level pre-processing may be needed.

Example 18 may include the non-transitory computer-readable medium of example 16 and/or some other example herein, wherein the operations further comprise: determining that the connected device processing capability may be low or no processing; and adding additional system level pre-processing.

Example 19 may include a method comprising: establishing, by one or more processors, a connection to a connected device; calculating a first SNR of a first sample of a first audio stream from the connected device; calculating a second SNR of a second sample of a second audio stream from a first device; comparing a difference of the first SNR and the second SNR to a Delta SNR threshold; and determining whether to apply system-level preprocessing based on the comparison.

Example 20 may include the method of example 19 and/or some other example herein, wherein the first sample and the second sample are captured simultaneously.

Example 21 may include the method of example 19 and/or some other example herein, wherein the connected device may be a universal serial bus (USB) or a Bluetooth® device.

Example 22 may include the method of example 19 and/or some other example herein, further comprising detecting ambient noise level conditions.

Example 23 may include the method of example 22 and/or some other example herein, wherein the Delta SNR threshold may be based on the ambient noise level conditions.

Example 24 may include the method of example 19 and/or some other example herein, further comprising update a profile list associated with a noise reduction processing capability of the connected device.

Example 25 may include the method of example 19 and/or some other example herein, wherein a processing capability of the connected device comprises a no processing capability, a good processing capability, or a low processing capability.

Example 26 may include the method of example 25 and/or some other example herein, further comprising: determining that the connected device processing capability may be good; and determining no additional system level pre-processing may be needed.

Example 27 may include the method of example 25 and/or some other example herein, further comprising: determining that the connected device processing capability may be low or no processing; and adding additional system level pre-processing.

Example 28 may include an apparatus comprising means for: establishing a connection to a connected device; calculating a first SNR of a first sample of a first audio stream from the connected device; calculating a second SNR of a second sample of a second audio stream from a first device; comparing a difference of the first SNR and the second SNR to a Delta SNR threshold; and determining whether to apply system-level preprocessing based on the comparison.

Example 29 may include the apparatus of example 28 and/or some other example herein, wherein the first sample and the second sample are captured simultaneously.

Example 30 may include the apparatus of example 28 and/or some other example herein, wherein the connected device may be a universal serial bus (USB) or a Bluetooth® device.

Example 31 may include the apparatus of example 28 and/or some other example herein, further comprising detecting ambient noise level conditions.

Example 32 may include the apparatus of example 31 and/or some other example herein, wherein the Delta SNR threshold may be based on the ambient noise level conditions.

Example 33 may include the apparatus of example 28 and/or some other example herein, further comprising update a profile list associated with a noise reduction processing capability of the connected device.

Example 34 may include the apparatus of example 28 and/or some other example herein, wherein a processing capability of the connected device comprises a no processing capability, a good processing capability, or a low processing capability.

Example 35 may include the apparatus of example 34 and/or some other example herein, further comprising: determining that the connected device processing capability may be good; and determining no additional system level pre-processing may be needed.

Example 36 may include the apparatus of example 34 and/or some other example herein, further comprising: determining that the connected device processing capability may be low or no processing; and adding additional system level pre-processing.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system, comprising: at least one memory that stores computer-executable instructions; and at least one processor configured to access the at least one memory and execute the computer-executable instructions to:
establish a connection to a connected device;
calculate a first SNR of a first sample of a first audio stream from the connected device;
calculate a second SNR of a second sample of a second audio stream from a first device;
compare a difference of the first SNR and the second SNR to a Delta SNR threshold; and
determine whether to apply system-level preprocessing based on the comparison.

2. The system of claim 1, wherein the first sample and the second sample are captured simultaneously.

3. The system of claim 1, wherein the connected device is a universal serial bus (USB) or a Bluetooth® device.

4. The system of claim 1, wherein the processing circuitry is further configured to detect ambient noise level conditions.

5. The system of claim 4, wherein the Delta SNR threshold is based on the ambient noise level conditions.

6. The system of claim 1, wherein the processing circuitry is further configured to update a profile list associated with a noise reduction processing capability of the connected device.

7. The system of claim 1, wherein a processing capability of the connected device comprises a no processing capability, a good processing capability, or a low processing capability.

8. The system of claim 7, wherein the processing circuitry is further configured to:
determine that the connected device processing capability is good; and
determine no additional system level pre-processing is needed.

9. The system of claim 7, wherein the processing circuitry is further configured to:
determine that the connected device processing capability is low or no processing; and
add additional system level pre-processing.

10. A non-transitory computer-readable medium storing computer-executable instructions which when executed by one or more processors result in performing operations comprising:
establishing a connection to a connected device;
calculating a first SNR of a first sample of a first audio stream from the connected device;
calculating a second SNR of a second sample of a second audio stream from a first device;
comparing a difference of the first SNR and the second SNR to a Delta SNR threshold; and
determining whether to apply system-level preprocessing based on the comparison.

11. The non-transitory computer-readable medium of claim 10, wherein the first sample and the second sample are captured simultaneously.

12. The non-transitory computer-readable medium of claim 10, wherein the connected device is a universal serial bus (USB) or a Bluetooth® device.

13. The non-transitory computer-readable medium of claim 10, wherein the operations further comprise detecting ambient noise level conditions.

14. The non-transitory computer-readable medium of claim 13, wherein the Delta SNR threshold is based on the ambient noise level conditions.

15. The non-transitory computer-readable medium of claim 10, wherein the operations further comprise update a profile list associated with a noise reduction processing capability of the connected device.

16. The non-transitory computer-readable medium of claim 10, wherein a processing capability of the connected device comprises a no processing capability, a good processing capability, or a low processing capability.

17. The non-transitory computer-readable medium of claim 16, wherein the operations further comprise:
determining that the connected device processing capability is good; and
determining no additional system level pre-processing is needed.

18. The non-transitory computer-readable medium of claim 16, wherein the operations further comprise:
determining that the connected device processing capability is low or no processing;
and
adding additional system level pre-processing.

19. A method comprising:
establishing, by one or more processors, a connection to a connected device;
calculating a first SNR of a first sample of a first audio stream from the connected device;
calculating a second SNR of a second sample of a second audio stream from a first device;
comparing a difference of the first SNR and the second SNR to a Delta SNR threshold; and
determining whether to apply system-level preprocessing based on the comparison.

20. The method of claim 19, wherein the first sample and the second sample are captured simultaneously.
